(19) United States
(12) Patent Application Publication
(10) Pub. No.: US 2026/0109072 A1
(43) Pub. Date: Apr. 23, 2026

(54) A METHOD FOR PRODUCTION OF A GUIDE BAR FOR A CHAINSAW, A GUIDE BAR FOR A CHAINSAW, AND A GUIDE BAR BLANK

(71) Applicant: HUSQVARNA AB, Huskvarna (SE)

(72) Inventor: Christian LILIEGARD, Jonkoping (SE)

(21) Appl. No.: 19/111,509

(22) PCT Filed: Sep. 15, 2023
(86) PCT No.: PCT/SE2023/050911

§ 371 Date: Mar. 13, 2025

(30) Foreign Application Priority Data
Oct. 14, 2022 (SE) 2251208-1

(51) Int. Cl. B27B 17/02; B23D 65/00

(52) U.S. Cl. CPC B27B 17/025; B23D 65/00

(57) ABSTRACT

The present disclosure related to a method (100) for production of a chainsaw guide bar (5). The method (100) comprises the steps of providing (120) two elongated side plates (23a, 23b), wherein at least one of the side plates (23a, 23b) is provided with an alignment aperture (31b). Providing (140) a core plate (25) which is connected to an alignment plate (33) comprising an alignment aperture (31a). Positioning (160) a side plate (23a, 23b) on each side of the core plate ((25). Aligning (180) the core plate (25) to the side plates (23a, 23b) such that the alignment aperture (31a) of the core plate (25) is in register with the alignment aperture (31b) of the at least one side plate (23a, 23b). Joining (200) the core plate (25) and the side plates (23a, 23b) to form an elongated guide bar (5) and removing (200) the alignment plate (33) from the core plate (25). The disclosure also relates to a guide bar (5) for a chainsaw (1). The guide bar (5) is produced according to the method (100). The disclosure also relates to a guide bar blank.

### FIELD OF THE INVENTION

The present invention relates to the field of chainsaws, especially to a guide bar, and a method for production of a guide bar.

### BACKGROUND

Chainsaws are commonly used in both private and commercial contexts to cut timber or perform other rigorous cutting operations. They can be powered by gasoline engines or electric motors (e.g., via batteries or wired connections) to turn a chain around a guide bar at high speed. The chain includes cutting teeth that engage with lumber or other material to cut the material as the teeth pass over a surface of the material at high speed.

Guide bars normally have a laminate structure, including an inner layer or plate member which is sandwiched between a pair of outer layers or plate members. The inner layer typically has a smaller length and width than the outer layers, which are otherwise substantially identically shaped, so that a guide groove around the entire periphery of the guide bar is defined between the outer layers. When the guide bar is used in a chainsaw, guide teeth of the saw chain slide within this groove.

EP 1 448 344 describes an exemplary laminated guide bar to be used in a chainsaw. There is however always a need for further improvements of a laminated guide bar and the method of production of a laminated guide bar to cope with tough operating conditions of a chainsaw and to improve the performance of the chainsaw.

### SUMMARY

It is an object of the present invention to solve, or at least mitigate, parts or all the above-mentioned problems. To this end, there is provided a method for production of a chainsaw guide bar. The method comprises providing two elongated side plates, wherein at least one of the side plates is provided with an alignment aperture. Providing an elongated the core plate, wherein the core plate is connected to an alignment plate comprising an alignment aperture. Positioning a side plate on each side of the core plate. Aligning the core plate to the side plates, such that the alignment aperture of the alignment plate is in register with the alignment aperture of the at least one side plate. Joining the core plate and the side plates to form an elongated guide bar and removing the alignment plate from the core plate.

The three plates may be attached to each other by welding, normally spot welding or pressure welding. During the lamination process, the plates need to be kept aligned. To this end an alignment aperture may be provided. The alignment aperture of the core plate may have the same shape and/or size as the alignment aperture of the at least one side plate. The alignment aperture of the core plate is kept in register with the alignment aperture of the at least one side plate during the lamination process. The alignment plate and the core plate may be arranged in the same plane. The core plate may have a length in the longitudinal direction and the alignment plate may be connected to a front edge of the core plate. By providing the alignment aperture in the alignment plate, which alignment plate is to be removed after joining of the guide bar, a guide bar with light weight can be provided. In conventional guide bars, an alignment aperture may be provided close to the middle of the core plate in the longitudinal direction thereof. These guide bars do not allow the same weight reduction as a core plate with a removable alignment plate, because the alignment aperture needs to be surrounded by material. By arranging an alignment aperture near the front of the core plate and close to the front of the side plate makes it possible to obtain a small angle error in the alignment during the joining of the plates. The core plate and the side plate may also be provided with a further alignment aperture close to the rear end of each plate. These further alignment apertures may also be used for attaching the guide bar to a chain saw after the plates have been joined.

Preferably, each of the side plates may be provided with a respective alignment aperture that is positioned in register with the alignment aperture of the core plate before joining the plates. This facilitates the alignment of the plates, and the angle error of the alignment may be further reduced.

In one embodiment, the alignment aperture in the at least one side plate and in the core plate is a through hole. This facilitates the use of a tool used for alignment during lamination of the plates. It also makes it possible to easily cover the alignment holes after the lamination to avoid debris getting stuck in the hole when the guide bar is used for sawing.

Preferably, the step of alignment of the core plate to the side plates may comprise inserting an alignment tool through said alignment apertures of the core plates and the at least one side plate. Such a tool may be a fixture consisting of a flat plate with pins extending perpendicular to the plate. Each pin may be inserted through a corresponding alignment aperture in the plates to keep the plates in register during joining of the plates. The tool can then be removed from the formed guide bar before removing the alignment plate from the core plate.

Preferably, providing the core plate and the side plates may further comprise providing plates that each extends along a plane, and in said plane having a length in the longitudinal direction and a respective width perpendicular to the longitudinal direction, wherein the length and width of the core plate are smaller than a corresponding length and width of each side plate. A side edge of the core plate defines the bottom of a track configured to guide the saw chain when the guide bar is connected to a chain saw. The alignment plate may be connected to a front edge of the core plate.

In one embodiment, the method may further comprise after joining the side plates and the core plate, plugging the alignment aperture of the at least one side plate. In this way, debris from sawing may be prevented from ending up in the aperture. The upper side and/or the underside of the guide bar may become flat, which improves the appearance of guide bar. This area may also be used for displaying advertising or performance data.

Preferably, the method may further comprise positioning of a nose sprocket arrangement between the side plates after removal of the alignment plate from the core plate. When the alignment plate is removed from the core plate, a space is formed between the side plates in the front edge of the guide bar since the core plate has a smaller length and width than a corresponding length and width of the side plates. In this space it is possible to arrange a nose sprocket arrangement, which can comprise a nose wheel that is rotatable to interface with the saw chain as the saw chain turns around the front end of the guide bar.

Preferably, the method may comprise connecting the nose sprocket arrangement to the guide bar through the alignment apertures of the side plates. In this way, the existing apertures can be used to attach the nose sprocket arrangement to the guide bar. No separate apertures for aligning the plates during joining the plates will be needed.

In one embodiment, the nose sprocket arrangement may be connected to the guide bar using at least one rivet. The nose sprocket arrangement may be attached to the guide bar with one or several rivets through apertures in the side plates. One of the apertures may be also used for aligning the plates during the joining process. Preferably an aperture arranged in a centre line of the side plate may be used as the alignment aperture.

Preferably, the alignment plate, prior to the removal, may be rigidly connected to the core plate. The plates need to be kept in register during the lamination process to form a guide bar with a side edge of the core plate that defines a guide groove configured to guide the saw chain when the guide bar is connected to a chain saw, thus the core plate and the alignment plate needs to be rigidly connected to each other in the same plane during this joining process.

Preferably, the core plate may be integrally formed with the alignment plate. A single piece of material may be used for both the core plate and the alignment plate which may reduce production costs for the guide bar since time and material can be earned.

In one embodiment, the core plate may be provided by cutting or punching of a core plate blank to form the core plate and the alignment plate with an intermittent gap between the core plate and the alignment plate.

Preferably, a rear end of the core plate comprises a guide bar connection interface for connecting the guide bar to a chainsaw body, and a separation interface between the alignment plate and the core plate is positioned at a front end of the core plate, opposite to said rear end. The alignment plate will thus form a nose end of the core plate and will allow simple detachment from each other. Since the alignment aperture is arranged in the alignment plate the weight of the core plate and the formed guide bar can be reduced.

Preferably, the core plate and the alignment plate may be connected through at least one frangible bridge. The frangible bridge may be created as an interruption of the gap between the plates. To obtain a stability between the core plate and the alignment, two frangible bridges are placed above each other along a plane perpendicular to the plane of the plates.

Preferably, the at least one frangible bridge may be provided with a width of at least 0.3 mm, preferably 0.8-1 mm perpendicular to the plane of the core plate. The width of each frangible bridge should be thin enough so that remaining parts from the bridge after removal of the alignment plate does not tend to interfere with the nose sprocket arrangement and thick enough so that the bridge is not broken unintentionally during the joining process.

In one embodiment, a gripping portion of the alignment plate may extend from the guide bar after the core plate and the side plates have been joined. The core plate has a smaller length than a corresponding length for each side plate. When the alignment plate is connected to the core plate, a part of the core plate will extend from a front part in the longitudinal direction of the guide bar when the plates are arranged in register with each other. This gripping portion may be used for disconnection of the alignment plate from the core plate. The gripping portion and the alignment plate may preferably be integrally formed. The gripping portion may be provided with a through hole or a hook. The shape may be elongated and formed as a rectangle or an oval. The shape should be easy to grasp with the fingers Preferably, removing of the alignment plate may comprise pulling the gripping portion of the alignment plate along a plane of the guide bar, preferably in a direction transversal to the longitudinal direction of the guide bar. This may automatically facilitate removal of the alignment plate from the core plate and the production cost for the guide bar may be reduced.

Preferably, providing the core plate may further comprise providing the core plate with a lightening hole arrangement which is fully covered by the side plates in the guide bar. The weight of the guide bar is an important parameter to facilitate for and increase the efficiency of the work for the operator of the chainsaw. By providing the core plate with at least one cut-out hole, the weight of the guide bar is reduced. The cut-out hole may be closed/covered by the side plates to maintain the stiffness of the guide bar. Depending on the desired degree of weight reduction and degree of accepted or justifiable reduction of stiffness, several cut-out holes may be provided, which may optionally be evenly distributed over the core plate. By way of example, about 50-90% of the area of the core plate may be provided with cut-out holes. The shape and the size for each of the cut-out hole may vary. The lightening hole arrangement can also be one, big hole with varied edge structure.

According to a second aspect, parts or all of the above-mentioned problems are solved, or at least mitigated, by a guide bar that has been produced with the method that has been described above. By moving the alignment aperture in the core plate to the front edge of the core plate, more material can be removed from the core plate which gives a lighter guide bar. The guide bar may also be more secure since an angle error may be reduced during joining of the plates. Since the alignment aperture in the core plate is removed after joining of the plates and the aperture in the side plates may be used for connection of the nose sprocket arrangement to the guide bar, there will be no apertures in the guide bar where wood debris may get stuck. An outside of the respective side plate will form a front side and a back side of the guide bar. These areas become flat which may improve the appearance of the guide bar and be used for affix and/or engrave advertising or product data.

According to a third aspect, part of or all the above-mentioned problems are solved or at least mitigated by a guide bar blank that may comprise a laminated structure of at least three layers comprising a first side plate, a second side plate and a core plate disposed between said first side plate and said second side plate. The core plate may be provided with a detachable alignment plate. This blank has all the above-mentioned advantages and thus will not be repeated.

It is noted that embodiments of the invention may be embodied by all possible combinations of features recited in the claims. Further, it will be appreciated that the various embodiments described for the device are all combinable with the method as defined in accordance with the second aspect of the present invention, and vice versa.

### BRIEF DESCRIPTION OF THE DRAWINGS

The above, as well as additional objects, features, and advantages of the present invention, will be better understood through the following illustrative and non-limiting detailed description of preferred embodiments of the present invention, with reference to the appended drawings, where the same reference numerals will be used for similar elements, wherein:

FIG. 1 illustrates a side view of a chainsaw;

FIG. 2 illustrates of side view of the guide bar in FIG. 1;

FIG. 3 illustrates a side view of a perforated core plate with an attached assignment plate;

FIG. 4 illustrates a side view of a guide bar comprising the core plate of FIG. 3;

FIG. 5 illustrates a side view of the guide bar of FIG. 4 when the assignment plate has been removed;

FIG. 6 illustrates a side view of the guide bar according to FIG. 5 with an attached nose sprocket arrangement; and

FIG. 7 illustrates a method for production of a guide bar.

All the figures are schematic, not necessarily to scale, and generally only show parts which are necessary to elucidate the embodiments, wherein other parts may be omitted.

### DETAILED DESCRIPTION OF THE EXEMPLARY EMBODIMENTS

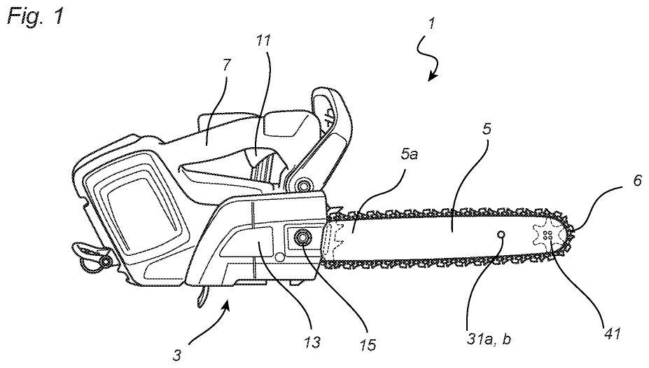

FIG. 1 illustrates a side view of a chainsaw 1. As shown in FIG. 1, the chainsaw 1 comprises a housing 3 inside which a power unit or motor is housed. The power unit may be either an electrical motor or an internal combustion engine. The chainsaw 1 further comprises a guide bar 5 attached to the housing 3 along one side thereof. The guide bar 5 extends outwardly from the housing 3. An endless saw chain loop 6 may be driven around the guide bar 5 responsive to operation of the power unit to enable the chainsaw 1 to cut lumber or other materials. The chainsaw 1 may also comprise a set of handles 7, one of which is provided with a trigger 11 to facilitate the operation of the power unit when the trigger 11 is actuated. When the trigger 11 is actuated (for example, depressed), the rotating forces by the power unit can be coupled to the saw chain 6. A clutch cover 13 may be provided to secure a rear end 5a of the guide bar 5 to the housing 3 and cover the clutch between the parts and components, which connects the power unit to the saw chain 6. As shown in FIG. 1, the clutch cover 13 may be attached to the housing 3 via screw-nuts 15 that also pass through the rear portion 5a of the guide bar 5.

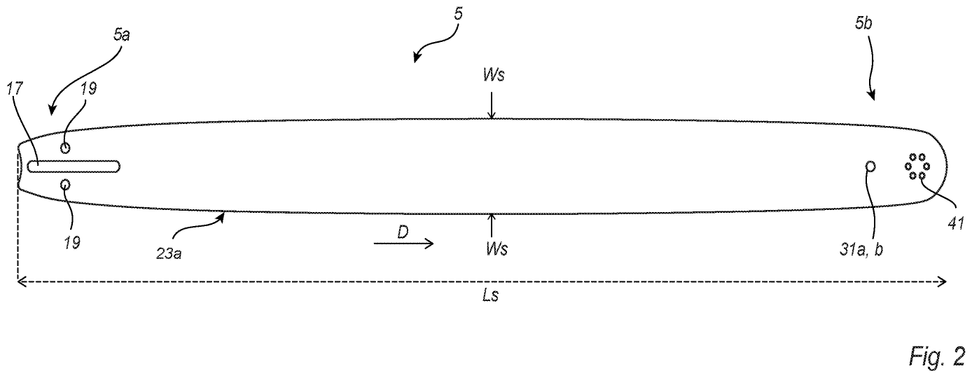

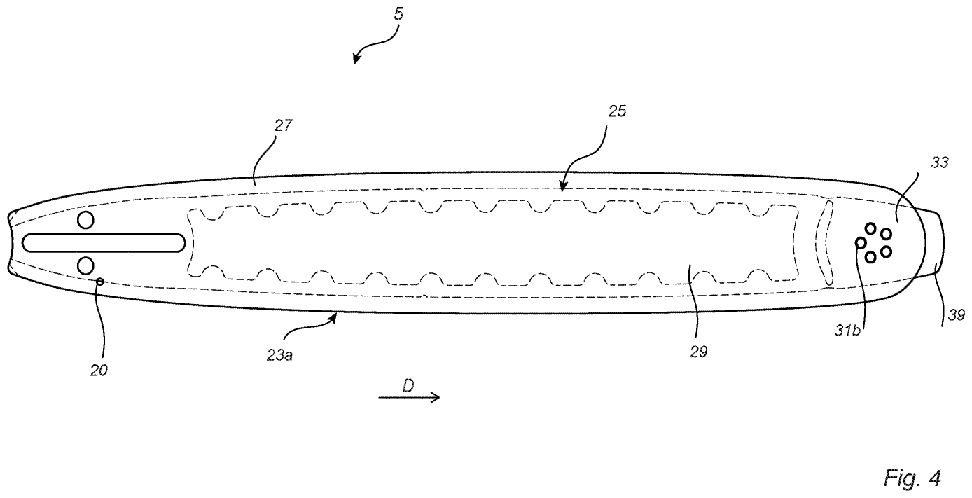

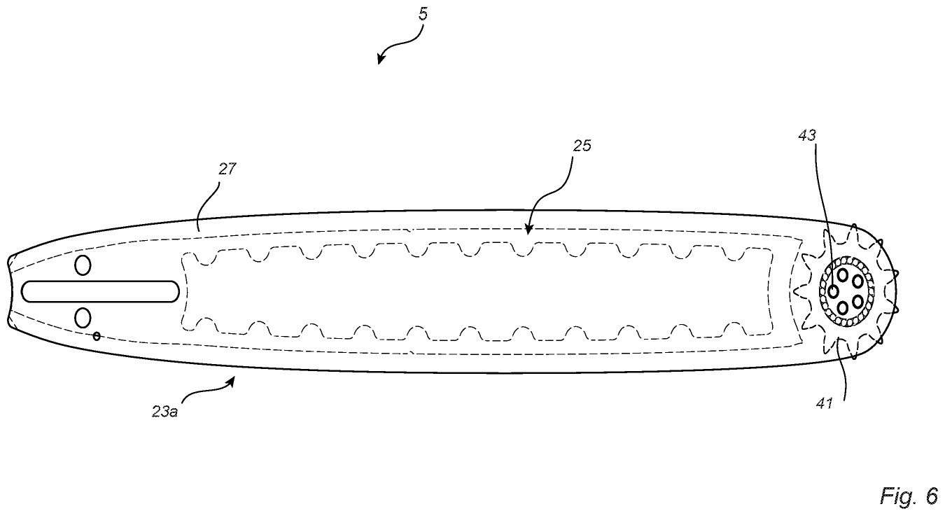

FIG. 2 illustrates a side view of the guide bar 5 according to FIG. 1. The guide bar 5 is elongate and has a rear end 5a to be mounted to the housing 3 of the chainsaw 1, as seen in FIG. 1, or to the engine, and a front end 5b opposite from the rear end 5a in the longitudinal direction D of the guide bar 5. The length of the guide bar 5 may vary depending on the application. It can have a length of for example 13, 15 or 18 inches and may be substantially longer than the chainsaw 1. The front end 5b of the guide bar 5 may house a nose sprocket arrangement 41, which can comprise a sprocket wheel, as indicated in FIG. 6, that is rotatable to interface with the saw chain 6 as the saw chain turns around the front end 5b of the guide bar 5. The rear end 5a of the guide bar 5 may be provided with a slot 17 and orifices 19 provided on either side of the slot 17 (above and below the slot) to fix guide bar 5 to the housing 3 via the screw nuts 15, as seen in FIG. 1. The guide bar 5 can be secured with tightening of the screw nuts 15, and a tightness of the saw chain 6 can be adjusted on movement of the guide bar 5 and subsequent tightening of the screw nuts 15 when the desired chain tightness is achieved. As indicated in FIGS. 4-6, the rear end 5a of the guide bar 5 may be provided with a further orifice 20 used for lubrication of the saw chain.

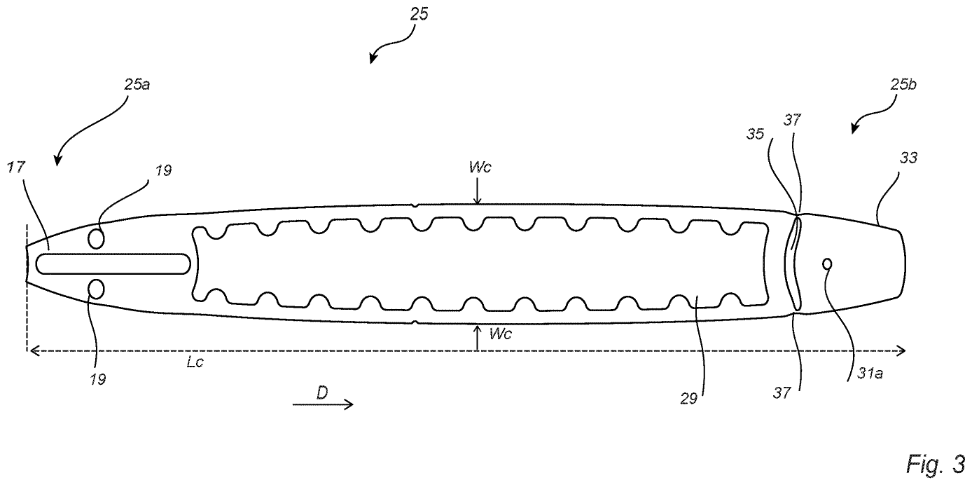

The guide bar 5 may be formed as a three-piece laminate, having a pair of side plates 23a, 23b and a core plate 25 (see FIGS. 3-6). Only one of the side plates 23a is shown in FIG. 2, an identical plate is arranged on the opposite side of the core plate 25.

The core plate 25 is illustrated with details in FIG. 3. The core plate 25 is sandwiched between the side plates 23a, 23b. The side plates 23a, 23b are normally made of the same material, which may be steel or other enough rigid and durable materials. The core plate 25 can be made of another material than the side plates 23a, 23b. The core plate 25 can have a smaller length Lc and width Wc than a corresponding length Ls and width Ws of the side plates 23 a, 23b, which are identically shaped so that a guide groove 27, see FIG. 4, around the entire outer edge of the guide bar 5 is defined between the side plates 23a, 23b. Different types of saw chains 6 require different guide grooves 27, so depth and width of the groove 27 are selected to meet the requirements of the saw chain. The width of the guide groove 27 is determined by the thickness of the core plate 25 and the depth of the guide groove 27 is determined by the difference in length Lc, Ls and width Wc, Ws between the core plate 25 and the side plates 23a, 23b.

The three plates 23a, 23b, 25 can be attached to each other by welding, normally spot welding or pressure welding, brazing, adhesives and/or mechanical fasteners, such as rivets or bolts, and/or other well-known means for attachment.

After the plates 23a, 23b, 25 have been joined together, they may further be exposed for hardening and tempering. Hardening processes are used to impart specific mechanical properties to the guide bar 5 to increase durability, especially where the chain runs. Tempering is low temperature heat treatment (150-650° C.) designed to remove stress and brittleness caused by cooling and develop the desired mechanical properties.

FIG. 3 illustrates a side view of a perforated core plate 25 with an assignment plate 33. The core plate 25 is elongated and extends along a plane and has a length Lc in a longitudinal direction D and a width Wc perpendicular to the longitudinal direction D. The core plate 5 has a front end 25b and a rear end 25a. The front end 25b can be provided with at least one alignment aperture 31a used for alignment of the plates 23a, 23b, 25 during formation of a guide bar 5. The rear end 25a of the core plate 25 may also be provided with a slot 17 and orifices 19 provided on either side of the slot 17 (above and below the slot) to fix guide bar 5 to the housing 3 via the screw nuts 15, as seen in FIG. 1.

The weight of the core plate 25 and the formed guide bar 5 is an important parameter to facilitate and increase the efficiency of the work for the operator of the chainsaw 1. To reduce the weight of the guide bar 5, the core plate 25 may be provides with a lightening hole arrangement 29. This arrangement 29 can comprise several cut-out holes of different shapes and sizes or a single, big cut-out as indicated in FIG. 3. Up to 80% of the surface of the core plate 25 may be provided with a lightening hole arrangement 29 with sufficient stiffness maintained for the guide bar 5. In the formed guide bar 5, the lightening hole arrangement 29 is covered by the side plates 23a, 23b to form a closed space, as seen in FIG. 4.

Another alternative to reduce the weight of the guide bar 5 is to use a core plate 25 of a material with low density for example aluminium or a plastic material. If the core plate 25 is made of aluminium or a plastic material to reduce the weight of the guide bar 5, the manufacturing method of the guide bar 5 may get more complicated and make the guide bar 5 more costly.

The alignment aperture 31a, b can be a through hole. Alignment apertures 31a, b are provided in at least one side plates 23a, 23b and in the core plate 25 and has the same shape and/or size. The location of the alignment apertures 31a, b in the guide bar 5, as indicated in FIGS. 1 and 2 (closer to the center of the guide bar than the nose sprocket arrangement 41), requires blank material around the alignment aperture 31a and reduces the possibility for lightening hole arrangement 29 at this place which leads to a heavier core plate 25, which in turn leads to a heavier guide bar 5. A lighter guide bar 5 may be provided if the alignment apertures 31a, b is moved closer to the front end 5b of the guide bar 5. By providing the core plate 5 with an alignment plate 33 which contains the alignment aperture 31z, the alignment aperture 31a can be moved to the front end 25b of the core plate 25 as indicated in FIG. 3. The core plate 25 and the alignment plate 33 can be made by cutting and punching a core plate blank (not shown) to form the core plate 25 and the alignment plate 33 with an intermittent gap 35 between these plates 25, 33 that extends from the front end 25b of the core plate 25. The shape of the alignment plate 33 follows the shape of the core plate 25 such that a guide groove 27 is formed between the side plates 23a, 23b in the front end 5b of the guide bar 5 (FIGS. 4-6). There should preferably be at least one connection 37 between the core plate 25 and the alignment plate 33. This connection 37 may be formed as an interruption of the gap 35 formed between the parts 25, 33, creating a frangible bridge. The width of the frangible bridge 37 has been designed so that the alignment plate 33 can be handled during the production step(s) without detaching from the core plate 25 unintentionally, but it should still be possible to detach the alignment plate 33 from the core plate 25 in an efficient manner after the guide bar 5 has been formed. It has shown that a width of at least 0.3 mm and a length of at least 1 mm provides a cross sectional area of the frangible bridge 37 that can withstand a load of 1000 N and this is enough to manage the load during production. It is also possible to break the bridge 37 quite easily after the guide bar 5 has been formed. Preferably, the width is between 0.8-1 mm perpendicular to the plane of the guide bar 5. The length is preferably between 1-2 mm along an outer edge of the guide bar 5. The core plate in FIG. 3 indicates two frangible bridges 37, each arranged to form outer edges, in a direction transversal to the longitudinal direction D of the guide bar, of the gap 35 formed between the plates 25, 33. It is possible to arrange the frangible bridges 37 closer to each other.

During the joining process of the side plates 23a, 23b and the core plate 25, the plates 23, 23b; 25 need to be kept aligned to create a homogenous guide groove 27 along the periphery of the guide bar 5 (FIGS. 4-6). The alignment aperture 31a of the core plate 33 is placed in register with the alignment apertures 31b of the side plates 23a, 23b. An alignment tool (not shown) may be used for the alignment. This tool may be a fixture consisting of a flat plate with at least one pin extending perpendicular to the flat plate. The pin may be inserted through the alignment apertures 31a, b of the plates 23a, 23b, 25 to keep them aligned during the joining process. After a guide bar 5 has been formed, the alignment tool is removed from the guide bar 5. The alignment tool may also be provided with a second pin that can be placed in the slot 17 arranged in the rear end 25a of the core plate 25 and the side plates 23a, 23b to further hold the plates 23a, 23b, 25 in register during the joining process.

FIG. 4 illustrates a guide bar 5 after the plates 23a 23b, 25 have been joined together. A part of the assignment plate 33, a gripping portion 39, extends from the font edge 5a of the guide bar 5 in the longitudinal direction D thereof. The alignment plate 33 needs to be removed from the guide bar 5 before a nose sprocket arrangement 41, FIG. 6, can be attached to the guide bar 5. The gripping portion 39 may be integrally formed with the alignment plate 33 and can, for example, be a hole or a hook. The shape may be elongated and formed as a rectangle or an oval, which makes it easy to grip with the fingers. The gripping portion 39 may be gripped by fingers or automatically be pulled along a plane of the guide bar 5 in a direction transversal to the longitudinal direction D. The gripping portion 39 may also be provided with a passage (not shown). The passage can be centrally arranged in the gripping portion 39. An element may be introduced into passage to apply a force to break the frangible bridges 37 and thereby remove of the alignment plate 33 from the core plate 25. This step may be performed automatically.

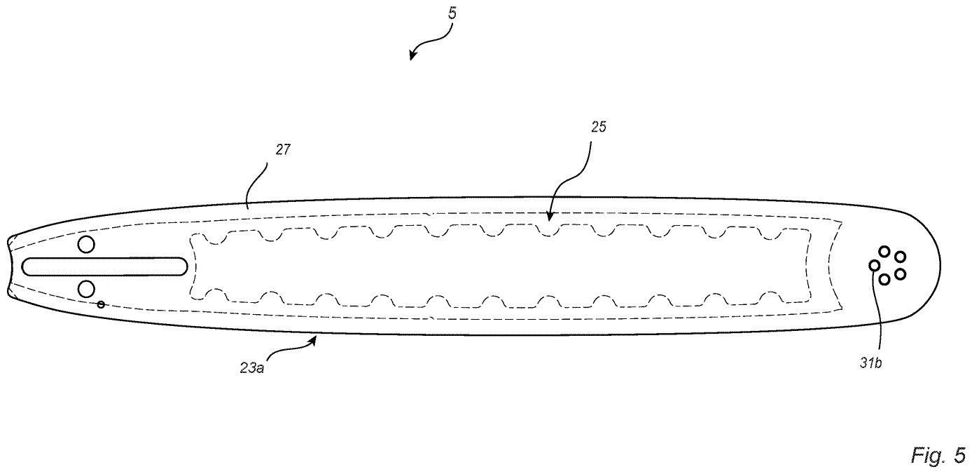

FIG. 5. Illustrates the formed guide bar 5 after the alignment plate 33 has been removed from the core plate 25. After formation of the guide bar 5, the alignment aperture 31b in at least one side plate 23a, 23b may be plugged to avoid that wood debris or other waste from getting stuck in the aperture while cutting. The alignment aperture 31 in at least one side plate 23a, 23b may be a hole for attachment of the nose sprocket arrangement 41 in the formed guide bar 5. If several holes a used for attachment of the nose sprocket arrangement 41, as indicated in FIG. 5, an aperture arranged in the centre line of the side plate 23a, 23b is used as the alignment aperture 31b. This alignment aperture 31b will be closed by a rivet 43 when the nose sprocket arrangement 41 is connected to the guide bar 5, as indicated in FIG. 6.

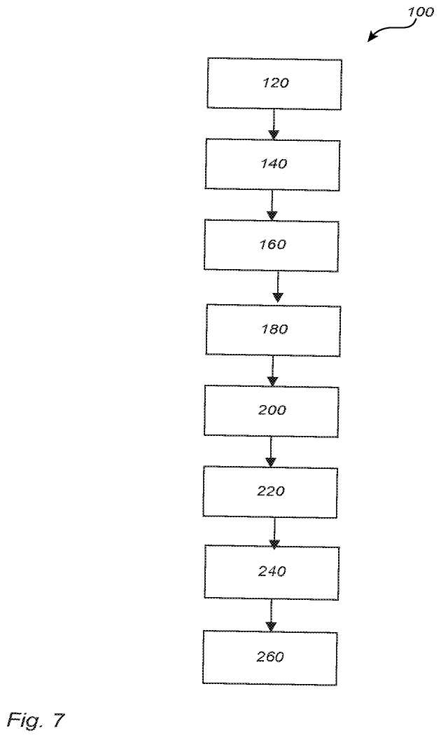

At production of the guide bar 5 according to the method 100, as shown in FIG. 7, two elongated side plates 23a,23b are first cut out 120, each from a single piece of material, wherein at least one side plate 23a, 23b is provided with an alignment aperture 31b. A perforated core plate 25 with an alignment plate 33 comprising an alignment aperture 31a and a gripping portion 39, wherein the core plate 25 and the alignment plate 33 are attached to each other through at least one frangible bridge 37, is then cut 140 out from a single piece of sheet metal. The core plate 25 is sandwiched 160 between a pair of side plates 23a, 23b and the plates 23a, 23b, 25 are aligned 180 to each other such that the alignment aperture 31a of the core plate 25 is in register with the alignment aperture 31b of at least one side plate 23a, 23b. The plates 23a, 23b, 25 are the joined together 200, for example by welding, to form an elongated guide bar 5. The alignment plate 33 may then be removed 220 from the guide bar 5 to provide a space for a nose sprocket arrangement 41. A nose sprocket arrangement 41 may be positioned 240 between the side plates 23a, 23b and connected 260 to the guide bar 5 through the alignment apertures 31b of the side plates.

The invention has been described above with reference to a few embodiments. However, as is readily appreciated by a person skilled in the art, other embodiments than the ones disclosed above are equally possible within the scope of the invention, as defined by the appended patent claims.

In the claims, the word “comprising” does not exclude other elements or steps, and the indefinite article “a” or “an” does not exclude a plurality.

1. A method for production of a chainsaw guide bar, the method comprising;
providing two elongated side plates, wherein at least one of the side plates is provided with an alignment aperture;
providing an elongated the core plate, wherein the core plate is connected to an alignment plate comprising an alignment aperture;
positioning a side plate on each side of the core plate;
aligning the core plate to the side plates, such that the alignment aperture of the alignment plate is in register with the alignment aperture of the at least one side plate;
joining the core plate and the side plates to form an elongated guide bar and
the alignment plate from the core plate.

2. The method according to claim 1, wherein each of the side plates is provided with a respective alignment aperture that is positioned in register with the alignment aperture of the core plate before joining the plates.

3. The method according to claim 1, wherein the alignment aperture in the at least one side plate and in the core plate is a through hole.

4. The method according to claim 1, wherein aligning the core plate to the side plates comprises inserting an alignment tool through said alignment aperture of the core plate and said alignment aperture of the at least one side plate.

5. The method according to claim 1, wherein providing the core plate and the side plates further comprises providing core and side plates that each extend along a plane, and in said plane having a respective length in a longitudinal direction and a respective width perpendicular to the longitudinal direction, wherein the length and width of the core plate are smaller than a corresponding length and width of each side plate.

6. The method according to any claim 1, further comprising after joining the side plates and the core plate, plugging the alignment aperture of the at least one side plate.

7. The method according to claim 1, further comprising positioning of a nose sprocket arrangement between the side plates after removal of the alignment plate from the core plate.

8. The method according to claim 7, further comprising connecting the nose sprocket arrangement to the guide bar through the alignment aperture of the at least one side plate.

9. The method according to claim 8, wherein the nose sprocket arrangement is connected to the guide bar using at least one rivet.

10. The method according to claim 1, wherein the alignment plate, prior to the removal, is rigidly connected to the core plate.

11. The method according to claim 1, wherein the core plate is integrally formed with the alignment plate.

12. The method according to claim 1, wherein providing the core plate further comprises cutting or punching of a core plate blank to form the core plate and the alignment plate with an intermittent gap between the core plate and the alignment plate.

13. The method according to claim 1, wherein a rear end of the core plate comprises a guide bar connection interface for connecting the guide bar to a chainsaw body, and a separation interface between the alignment plate and the core plate is positioned at a front end of the core plate, opposite to said rear end.

14. The method according to claim 1, wherein the core plate and the alignment plate are connected through at least one frangible bridge.

15. The method according to claim 13, wherein the at least one frangible bridge has a width of at least 0.3 mm perpendicular to the plane of the core plate.

16. The method according to claim 1, wherein after joining the core plate and the side plates, a gripping portion of the alignment plate extends from the core plate.

17. The method according to claim 15, wherein removing the alignment plate from the core plate comprising pulling the gripping portion of the alignment plate along a plane of the guide bar.

18. The method according to claim 1, wherein the core plate comprises a lightening hole arrangement which is fully covered by the side plates in the guide bar.

19. A guide bar for a chainsaw, wherein the guide bar has been produced with the method according to claim 1.

20. A guide bar blank comprising a laminated structure of at least three layers comprising a first side plate, a second side plate and a core plate disposed between said first side plate and said second side plate, wherein the core plate is provided with a detachable alignment plate.
